(19) United States
(12) Patent Application Publication
(10) Pub. No.: US 2024/0180057 A1
(43) Pub. Date: Jun. 6, 2024

(54) ROW FOLLOWER TRAINING

(71) Applicant: Zimeno Inc., Livermore, CA (US)

(72) Inventor: Rama Venkata BHUPATIRAJU, Fremont, CA (US)

(73) Assignee: Zimeno Inc., Livermore, CA (US)

(21) Appl. No.: 18/522,156

(22) Filed: Nov. 28, 2023

Related U.S. Application Data
(60) Provisional application No. 63/524,849, filed on Jul. 3, 2023.
(60) Provisional application No. 63/429,162, filed on Dec. 1, 2022.

(51) Int. Cl. A01B 69/04; A01B 69/00; B62D 6/00; G05B 13/02

(52) U.S. Cl. CPC A01B 69/008; A01B 69/004; B62D 6/001; G05B 13/027

(57) ABSTRACT

Images are captured with a camera from between consecutive rows as the camera is moved along consecutive rows. A verification is made as to whether the row follower vehicle is at a targeted row position during the capture of the images. The images are output to a machine learning model to train the machine learning model to determine whether the row follower vehicle is at the targeted row position based on images from the camera and verification that the row follower vehicle is at the targeted row position during capture of the images.

### CROSS-REFERENCE TO RELATED APPLICATIONS

The present non-provisional application claims benefit from co-pending U.S. provisional patent Application Ser. No. 63/429,162 filed on Dec. 1, 2022, by Rama Venkata Bhupatiraju and entitled AUTOMATIC TRAINING OF ROW FOLLOWER MODELS, and benefit from co-pending U.S. provisional patent Application Ser. No. 63/524,849 filed on Jul. 3, 2023, by Gatten et al. and entitled VEHICLE CONTROL, the full disclosures of which are hereby incorporated by reference.

### BACKGROUND

Vehicles are steered by the vehicle's steering system. The steering system may comprise mechanical, electrical and hydraulic components that react to a steering command to turn the wheels or tracks of the vehicle. Some vehicles include a steering wheel or other mechanical input device by which an operator may provide a steering command. Autonomous vehicles may have a controller that outputs control signals according to a steering and navigation routine or program, wherein the control signals serve as a steering command for the steering system.

### BRIEF DESCRIPTION OF THE DRAWINGS

FIG. 1 is a diagram schematically illustrating portions of an example row follower training system.

FIG. 2 is a flow diagram of an example row follower training method.

FIG. 3 is a diagram schematically illustrating portions of an example row follower training system.

FIG. 4A is a diagram schematically illustrating portions of an example row follower training system.

FIG. 4B is a diagram schematically illustrating portions of an example row follower training system.

FIG. 5 is a perspective view illustrating portions of an example row follower training system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example row follower training systems, vehicles and methods that provide automated steering for a row follower vehicle to maintain the vehicle at targeted row positions (TRPs). A TRP refers to the positioning of a vehicle relative to a plant row or relative to multiple plant rows. The TRP may be a position that avoids contact of the vehicle with the plant row or rows or may be a position that facilitates a particular interaction with plans of the plant row or rows.

A TRP may be a position at which at least portions of the vehicle are within navigable spaces between rows. For example, the vehicle may be within a “navigable space” when the chassis or frame of the vehicle is between consecutive rows or when the chassis or frame extends over plant rows, but left and right wheels/tracks of the vehicle are positioned between respective pairs of consecutive rows.

A TRP may be a position at which multiple plant interfaces of the vehicle are within spaces between multiple consecutive pairs of plant rows. For example, a TRP may be a position at which row dividers extend between plant rows and funnel or channel the plant rows for harvesting. A TRP may be a position at which plant interfaces physically contact and interact with plant rows from a side of the plant rows. A TRP may be a position at which multiple plant interfaces are aligned with respective plant rows, such as where the plant interfaces extend directly overhead respective plant rows as the vehicle travels along the plant rows.

Such plant rows may be in the form of crop rows, vine rows, orchard rows or other agricultural rows. Such vehicles may be self-propelled vehicles or vehicles that are pushed or pulled, such as an implement pulled by a tractor. The example row follower training systems, vehicles and methods facilitate automated training of machine learning models, such as a deep learning models or a neural network, to identify TRPs based upon images captured by at least one camera carried by the row follower vehicle.

Following such training, the example systems, vehicles and methods may use the trained machine learning models to facilitate automated steering and control of such row follower vehicles in the absence of signals from a global positioning satellite (GPS) system or in the absence of a predetermined mapping of such rows. The trained machine learning models may be utilized to evaluate the current position of a vehicle based upon unlabeled images received from cameras. Based upon the evaluation, the turning and speed of the vehicle may be adjusted. In implementations where operations are being performed on adjacent plant rows, parameters of such operations may be adjusted based upon the positioning of the vehicle as determined from the unlabeled images using the trained machine learning model.

The example row follower training systems, vehicles and methods further provide for automatic adjustment of the trained model (neural network) (machine learning model or machine trained network) based upon subsequently received operator steering input. The automated correction of a model, such as a neural network, to identify TRPs may reduce time and costs associated with such training.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, a machine learning model refers to one or more processors that utilize artificial intelligence in that they utilize a network or model that is been trained based upon various source or sample data sets. One example of such a network or model is a fully convolutional neural network. Such networks may comprise vision transformers.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

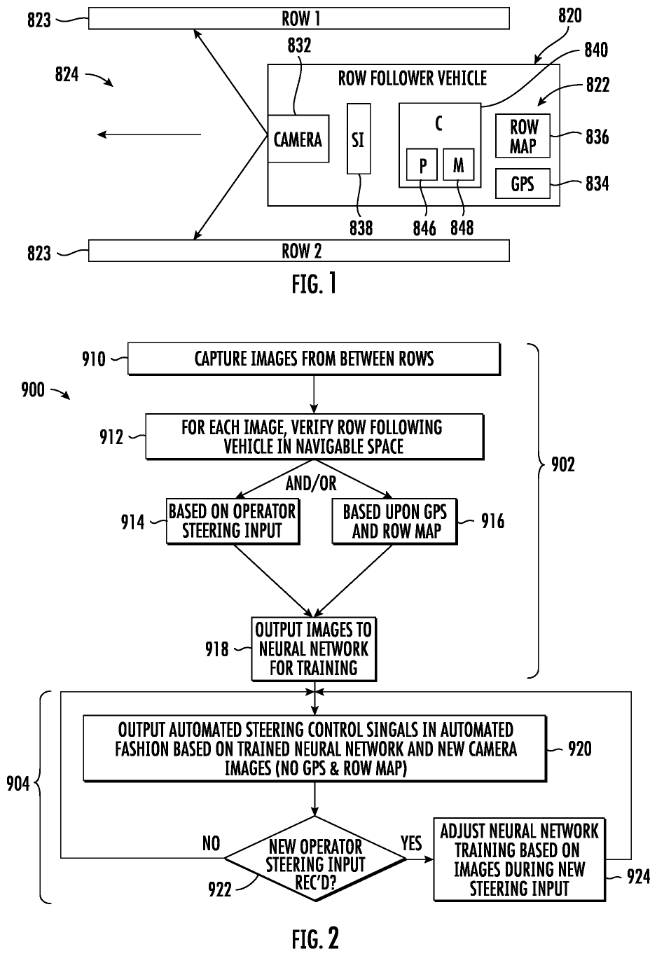

FIG. 1 schematically illustrates portions of an example row follower vehicle 820 having an example row follower training system 822. Row follower vehicle 820 comprises a vehicle for travel between a pair of consecutive plant rows 823, wherein the frame or chassis of vehicle 820 travels within a navigable space 824 between the pair of rows 823. The rows may be in the form of crop rows, vineyard rows, rows of trees or other plants in an orchard or the like. Such rows are separated by the navigable space 824.

In some implementations, the row follower vehicle 820 may move within the navigable space 824 between the rows 823. In some implementations, the row follower vehicle 820 may travel above and over top of multiple rows, wherein the traction members of the vehicle 820 (wheels or tracks) travel within and along navigable spaces 824 between consecutive rows. For example, tractor, sprayer or other vehicle may have a first wheel or first set of wheels that travel along a first navigable space between a first pair of rows and a second wheel or a second set of wheels that travel along a second navigable space between a second pair of rows.

In some implementations, the row follower vehicle may include different spaced portions, such as portions provided on a row head, wherein each of the spaced portions is to be moved along and within a navigable space between a corresponding pair of rows. For example, a harvester may include forwardly facing row dividers that are to be moved along and within navigable spaces between respective pairs of crop rows. The row follower vehicle 820 may be a self-propelled vehicle, such as a tractor, truck, harvester, or may be a pushed or pulled vehicle, such as an implement pulled by a self-propelled vehicle, the self-propelled vehicle being steered based upon images from a camera carried by the implement.

Row follower training system 822 is at least partially supported and carried by row follower vehicle 820. Row follower training system 822 is configured to train a machine learning model which may be subsequently used by the same row follower vehicle carrying the training system, with other row follower vehicles that may omit row follower training system 822, or the same or other row follower vehicles that may be operating in a region where either a global positioning satellite system is not available (no reliable signal) or where a map identifying the geographic location of the individual rows is not available. Row follower training system 822 may be provided with the row follower vehicle 820 or may be provided as a module or kit for mounting to an existing row follower vehicle. Row follower training system 822 comprises camera 832, global positioning satellite (GPS) system 834, row map 836, steering input 838 and controller 840.

Camera 832 comprises at least one three-dimensional or stereo camera carried by row follower vehicle 820. Camera 832 has a field-of-view so as to capture images of navigable space 824, which may or may not include at least portions of one or both of rows 823. Camera 832 captures both images and 3D point cloud data. Image pixels are fused with 3D point cloud to provide XYZ (axes) and RGB (red, green, blue) of each point in 3D space. In some implementations, camera 832 may comprise at least one monocular camera.

GPS 834 is carried by row follower vehicle 820 and outputs signals indicating the geographic location of row follower vehicle 820. Row map 836 comprises a stored mapping of rows and navigable spaces between such rows. Row map 836 may be previously acquired or generated using satellite imagery data, including GPS points of various rows. Row map 836 may be stored locally on row follower vehicle 820 or may be remotely stored and accessed in a wired or wireless fashion by controller 840.

Steering input 838 comprises an input device by which an operator may provide steering commands to row follower vehicle 820 as at least portions of follower vehicle 820 are traveling along and within navigable spaces between consecutive rows. Steering input 838 may be locally provided and carried by row follower vehicle 820 where the operator resides on row follower vehicle 820 as row follower vehicle 820 travels along navigable spaces 824. Steering input 838 may be remote relative to row follower vehicle 820 such as where the operator remotely controls steering of row follower vehicle 820, wherein signals from the remote steering input 838 may be transmitted in a wireless fashion to a steering control unit carried by row follower vehicle 820. In some implementations, steering input 838 may comprise a steering wheel that locally resides on vehicle 820 and that is remote from row follower vehicle 820. In some implementations, steering input 83 may comprise a joystick or other operator interface that facilitates input of steering commands by an operator either residing on row follower vehicle 820 or remote from row follower vehicle 820.

Controller 840 carries out training of a deep learning or machine learning model, such as a neural network, wherein the model or neural network may identify navigable spaces between rows. Controller 840 may further carry out adjustment or corrections of the model or neural network based upon operator input using steering input 838 during the otherwise automated steering of row follower vehicle 820 (or another vehicle that is to move along rows) based upon a previously trained model or neural network.

Controller 840 comprises processing unit 846 and memory 848. Processing unit 846 follows instructions provided in memory 848. Memory 848 comprises a non-transitory computer-readable medium which contains such instructions. Following such instructions contained in memory 848, processing unit 846 carries out the example method 900 set forth in FIG. 2. In the example illustrated, controller 840 is carried by and provided on row follower vehicle 820 which is in the form of a self-propelled vehicle, such as a tractor. In some implementations, controller 840 may be remote, wherein control 840 communicates in a wireless fashion with the row follower vehicle 820. In some implementations, portions of row follower training system may be remote, portions may be carried upon a self-propelled vehicle and portions may be carried on an implement or attachment pushed or pulled by the self-propelled vehicle.

FIG. 2 is a flow diagram of the example method 900 that may be carried out by controller 840. Method 900 may be partitioned into a training portion 902 and an operational corrective portion 904. During the training portion 902, a deep learning or machine learning model, such as a neural network, is trained based upon images captured by camera 832 and a ground truth as provided GPS system 834 and row map 836 and/or operator input from steering input 838.

During the operational corrective portion 904, the previously trained model is used to steer the row follower vehicle 820 (or the self-propelled vehicle pushing or pulling the row follower vehicle) in an automated fashion. Such automated steering may be without the assistance of a global positioning satellite (GPS) system 834 and/or without the assistance of a row map 836. The operational portion 904 of method 900 may be carried out independent of the training portion 902 and may be carried out with respect to other vehicles that are to travel along rows, but which may not necessarily include GPS 834 and/or row map 836. The operational portion 904 of method 900 may likewise be carried out with the same vehicle which provided training for the model/neural network or with other vehicles within fields, vineyards or orchards different from the particular field(s), vineyard(s) or orchard(s) where the original training of the model or neural network took place.

During the operational portion 904, errors in the model or network may be identified and corrected. For example, an operator may be monitoring the automated steering of the row follower vehicle between or along rows. In response to an error, the operator may intervene and provide operator steering input using a steering input 838 or a similar steering input to correct the error, to avoid collision with the row. In response to such input, the system 822 may automatically adjust the training of the model or neural network using the images captured during and/or immediately prior to the operator correction.

As indicated by block 910, controller 840 outputs control signals causing camera 832 to capture images from between rows 823, capturing the navigable space 824. In some implementations, the camera 832 may capture multiple navigable spaces between multiple sets of rows 823, such as where the row follower vehicle travels over or across multiple rows.

As indicated by block 912, for each of the captured images, controller 840 (processing unit 846 following instructions contained in memory 848) verifies whether the row follower vehicle 820 is within the navigable space at the time the particular image was captured. In the example illustrated, such verification may be performed by two example techniques. As indicated by block 914, controller 940 may verify whether the row follower vehicle 820 was within a navigable space when the particular image was captured based upon operator steering input. In such an instance, control 840 may deem that the row follower vehicle 820 was within a navigable space as the row follower vehicle 820 was being steered by an operator when the image was captured. In circumstances where the operator accidentally steers a vehicle out of navigable space, the operator may provide this information to control 840 using an operator interface.

As indicated by block 916, controller 940 may verify whether the row follower vehicle 820 was within a navigable space 824 when the particular image was captured based upon signals from GPS 834 and row map 836. During such verification, when the vehicle being driven in between rows, the current location of the vehicle GPS is compared to the mapped row data. The heading of the vehicle with respect to the row and the offset of the vehicle with respect to a center of the navigable space 824 may be determined from such mapping data. This information may be used to label the particular image pixels as navigable spaces 824 or non-navigable spaces, such as a vine canopy, crop row, tree stem or the like.

As indicated by block 918, the labeled images may be output to a model such as a neural network, for training of the model. The processing unit 846 of controller 840 may be part of the neural network. The neural network or deep learning model may be subsequently used to identify navigable spaces for the vehicle 820 or other vehicles based solely upon subsequently captured images. The trained deep learning model or neural network may be subsequently used for the operational portion 904 of method 900.

As indicated by block 920, controller 840 of row follow vehicle 820 or a steering controller of another vehicle that is to travel between or along rows 823 outputs automated steering control signals in an automated fashion based upon (1) the trained deep learning model or trained neural network and (2) new camera images received from camera 832 or another camera carried by the vehicle. For example, the images captured by the camera 832 may be analyzed using the neural network or model to determine whether the vehicle is currently within the navigable space or spaces 824. Based on this determination, the controller may output steering commands to adjust the steering to ensure that the vehicle remains within the navigable space or spaces 824 or the vehicle is moved once again into the navigable space or spaces 824.

As indicated by block 922, in some implementations, the controller 840 which outputs the automated steering control signals may continuously or periodically monitor for new operator steering input received from the steering input 838 of the vehicle. For example, the controller may monitor for a steering override from the operator received in the form of the turning of the vehicle steering wheel by the operator. This may occur when the operator notices that the automated steering of the vehicle is steering the vehicle out of a navigable space, such as into collision with one of the rows 823.

As indicated by block 924, in response to determining in block 922 that a new operator input or operator override has been received by the vehicle, the controller may initiate an adjustment or correction of the neural network or deep learning model. This adjustment or correction may be based upon images captured by the camera immediately prior to and during receipt of the new operator steering input. In some implementations, this correction to the prior neural network or deep learning model may be transmitted to a remote server providing a remote database, wherein the model used by a fleet of such vehicles for automated steering may be adjusted based upon the images captured immediately prior to and during the receipt of the new operator steering override input.

FIG. 3 is a diagram schematically illustrating row follower vehicle 820 employed as part of a larger row follower training system 1000. FIG. 3 illustrates an example of how vehicle 820 may be utilized to assist generation or training of a machine learning model that itself may be assisting in the steering of other vehicles between plant rows in circumstances where row maps and/or GPS data may be unavailable. System 1000 comprises server 1002 which is in wireless communication with vehicle 820. Server 1002 may maintain a remote centralized machine learning model 1004. In some implementations, server 1002 and machine learning model 1004 are cloud-based. Machine learning model 1004 is trained to distinguish between navigable spaces and non-navigable spaces based upon pre-labeled training images depicting both navigable spaces and non-navigable spaces.

The acquisition of the training images and labeling (as either a navigable space or a non-navigable space) may be carried out in an automated fashion as described above. In particular, as vehicle 820 travels between consecutive plant rows 823, camera 832 captures images and wirelessly transmits such images to server 1002. In some implementations, or in some modes of operation, the labeling of images, as depicting navigable space or non-navigable space, is based upon signals from GPS 824 indicating the geographic locations/coordinates of positioning of vehicle 820 with respect to the geographic locations/coordinates of plant rows 823 as determined based upon row map 836. When the geographic coordinates of vehicle 820, as determined from GPS 834, are within or between the geographic coordinates of consecutive plant rows 823, as provided by row map 836, images captured at times are labeled as depicting navigable spaces.

In some implementations, or in some modes of operation, the labeling of images, as depicting navigable space or non-navigable space is based upon operator input received through steering input 838. When the course of vehicle 820 is not being altered by the operator, such as when vehicle 820 is being manually driven between plant rows, images captured at such times are labeled as depicting navigable space. However, when the operator is required to turn the steering wheel or provide other input to the steering input 838, presumably to avoid an oncoming encounter with a plant row, images captured at such times are labeled as depicting non-navigable space.

As indicated by arrow 1008, the labeled images are transmitted to server 1002 which adds to the collection of images serving as a basis for the training of machine learning model 1004. An initially trained machine learning model may be continuously or periodically updated with new images for enhanced performance. Once machine learning model 1004 has been initially trained, machine learning model 1004 may be used as a basis for evaluating future unlabeled images from a vehicle camera to determine whether the vehicle is presently traveling within or is about to travel within a navigable space or into a non-navigable space. FIG. 3 illustrates two example scenarios where machine learning model 1004 may be utilized to assist in the steering of vehicles within respective plant rows.

In a first scenario, the vehicle 1020 may have an onboard or local machine learning model 1024. Server 1002 may update the local machine learning model 1024 based upon images received from vehicle 820. The updated machine learning model 1024 may then be utilized by a controller of vehicle 1020 to evaluate the current position of vehicle 1020 based upon images captured by one or more cameras 832 of vehicle 1020. Said another way, the controller may utilize the updated machine learning model 1024 to determine whether vehicle 1020 is currently traveling within a navigable space between plant rows 823 or is on a trajectory for encountering such plant rows are potentially causing damage to such plants.

Such evaluation or analysis of the unlabeled images using machine learning model 1004 may indicate not only whether the vehicle is currently within a navigable space, but the relative positioning of vehicle 1020 with respect to the two consecutive plant rows 823 that are on either side of vehicle 1020. The controller of vehicle 1020 may accordingly adjust steering to remain within the navigable space between the plant rows or to remain better centered between such plant rows. As shown by FIG. 3, the vehicle 1020 may be receiving updates to its local machine learning model 1024 while the vehicle is in the same vineyard, field or orchard or is in a different vineyard, field or orchard.

As further shown by FIG. 3, in some implementations, the server 1002 (comprising at least one and memory containing instructions) may utilize the cloud-based machine learning model 1004 to steer and control a remote fleet of vehicles 1120-1 and 1120-2 (collectively referred to as vehicles 1120). Vehicles 1120 each include a local camera 832. Unlabeled images from the local camera 832 may be transmitted to server 1002 which then analyzes the images based upon the machine learning model 1004.

As with the local controller on vehicle 1020, server 1002 may utilize the updated machine learning model 1024 to determine whether the individual vehicles 1120 are currently traveling within their respective navigable spaces between plant rows 823 or on a trajectory for encountering such plant rows or potentially causing damage to such plants. Evaluation of the unlabeled images from vehicles 1120 may indicate not only whether the vehicle 1120 is currently within a navigable space, but the relative positioning of vehicle 1020 with respect to the two adjacent consecutive plant rows 823. Server 1002 may output and transmit steering control signals (SC) to each of the vehicle 1120 to accordingly adjust steering of such vehicles 1120 such that they remain within the navigable space between the plant rows or to remain better centered between such plant rows as they travel. Such steering control signals may further control or adjust a speed at which the vehicle is traveling. For example, the speed of the vehicle may be temporarily reduced for better allow for timely course adjustment of the vehicle in response to the analysis of the incoming images by the model 1004 (or 1024) indicating an oncoming encounter with a plant row.

In some implementations, system 1000 may employ multiple vehicles 820 which continuously supply labeled images for continuously updating machine learning model 1004 or machine learning models 1024 of other vehicles which may not have access to GPS, or which may be operating in regions where row maps are not available. In some implementations, machine learning model 1004 or machine learning model 1024 may indicate, based upon unlabeled images received from such vehicles, that the particular vehicles are not within a navigable space. In circumstances where an existing row map 836 and GPS signals from GPS 834 of such vehicles indicate that the vehicle is within a navigable space, server 1002 or another server may utilize such information to update or correct the row map based upon the unlabeled images and their evaluation using the machine learning model.

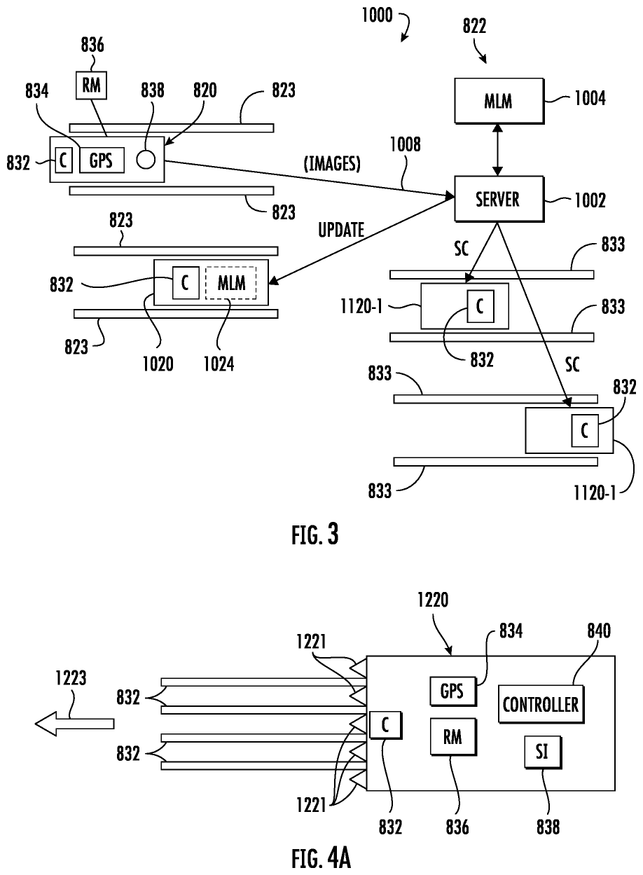

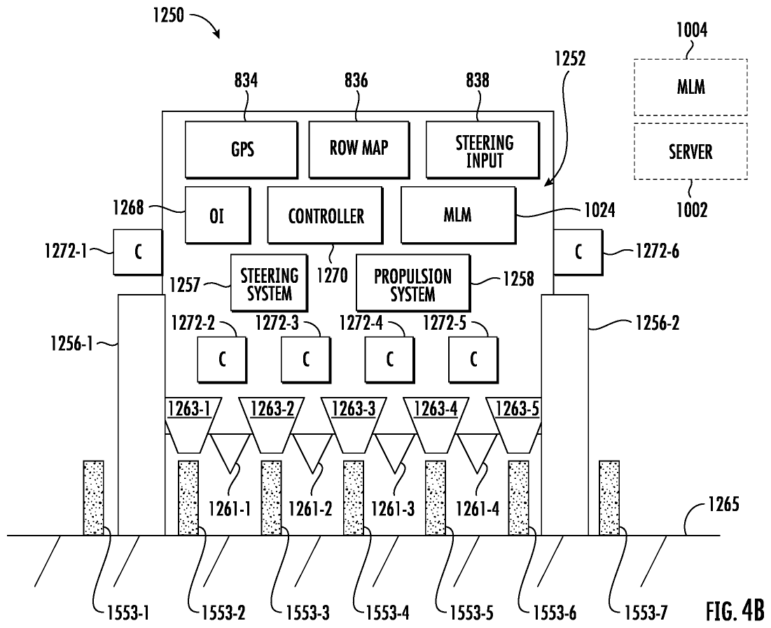

FIG. 4A is a diagram schematically illustrating portions of an example vehicle 1220. Unlike vehicle 820, vehicle 1220 is a type of vehicle configured to interact with multiple parallel rows at once while the vehicle 1220 traverses a field, vineyard, orchard or the like. Vehicle 1220 may include plant interfaces 1221 (schematically illustrated) that interact with or that are moved between consecutive plant rows as they interact with such plant rows. Examples of plant interfaces 1221 include, but not limited to, trimming or pruning devices, sprayers, crop row dividers (for example, the snouts on the front of a combine harvester), planters, and soil tillers, such as discs or plow blades. Examples of vehicles 1220 that include multiple plant interfaces 1221, include, but are limited to, harvesters, planters, corn detasselers, overhead sprayers and the like.

As with vehicle 820, vehicle 1220 may comprise camera 832, GPS 834, row map 836, steering input 838 and controller 840, each of which is described above. As of vehicle 820, vehicle 1220 may be utilized to generate, train and/or or update a machine learning model that is able to distinguish between navigable regions and non-navigable regions in unlabeled images captured by camera, such as camera 832, carried by a vehicle. The navigable spaces are the spaces, not through which the entire vehicle must travel, but the spaces along and between consecutive rows 833 through which the individual plant interfaces 1221 are to be moved (in the direction indicated by arrow 1223) as vehicle 1220 traverses the field, vineyard, orchard or the like.

FIG. 4B is a diagram schematically illustrating a front view of an example vehicle 1250 including an example row follower training system 1252. FIG. 4B illustrates an example of how a row follower training system may be utilized to train machine learning models for use in guiding the wheels, tracks or other ground engaging members between respective plant rows, for use in guiding plant interfaces between respective plant rows and/or aligning plant interfaces with respective plant rows as a vehicle travels along the plant rows. Vehicle 1250 comprises steered wheels 1256-1, 1256-2 (collectively referred to as wheels 1256), steering system 1257, propulsion system 1258, plant interfaces 1261-1, 1261-2, 1261-3, and 1261-4 (collectively referred to as plant interfaces 1261) and plant interfaces 1263-1, 1263-2, 1263-3, 1263-4 and 1263-5 (collectively referred to as plant interfaces 1263).

Steered wheels 1256 are configured to be turned or rotated by steering system 1258 and are configured to travel between respective consecutive plant rows as vehicle 1250 is traveling along such plant rows. In some implementations, wheels 1256 may alternatively comprise tracks. Steering system 1257 may comprise a set of gears, belts or other mechanisms configured to controllably rotate or steer wheels 1256. In some implementations, steering system 1257 may be a steer by wire system having an actuator such as an electric solenoid or hydraulic jack (cylinder-piston assembly) that controllably turns or steers wheels 1256. In some implementations, steering system 50 may include a rack and pinion steering system. Steering system 1257 actuates or turns wheels 1256 based upon steering control signals received from controller 1270 of vehicle 1250.

Propulsion system 1258 propels or drives vehicle 1250 in forward and rearward directions. In some implementations, propulsion system 1258 may comprise an internal combustion engine that outputs torque which is transmitted via a transmission to rear wheels of vehicle 1250. In some implementations, propulsion system 1258 comprises an electric motor that outputs torque which is transmitted via a transmission to rear wheels of vehicle 1250. In some implementations, propulsion system 1258 may comprise a hydraulic motor driven by a hydraulic pump which is driven by the electric motor, wherein the hydraulic motor drives front wheels 1256 to control a lead of such front wheels 1256. In some implementations, system 1258 may comprise a hybrid system. As should be appreciated, each of the vehicles described in this disclosure may include both the above-described steering system 1257 and the above-described propulsion system 1258.

Plant interfaces 1261 are similar to plant interfaces 1221 described above with respect to vehicle 1220. Plant interfaces 1261 are configured to move or travel between consecutive plant rows as they interact with plants (located to either side of the plant interfaces 1261) or interact with the ground 1265 between such plant rows. Plant interfaces 1261 may comprise row dividers (such as snouts on a harvester), planters, sprayers and/or soil tillers, such as discs or plow blades. As will be described hereafter, the trained machine learning model of row follower training system 1252 may be used to guide the positioning and movement of interfaces 1261 between respective consecutive plant rows 1253.

Plant interfaces 1263 may be similar to plant interfaces 1261 except that plant interfaces 1263 interact with plants of plant rows 1253 while being aligned with or directly over such plant rows. Plant interfaces 1263 may comprise sprayers, particulate spreaders, pruners, detasselers, or other mechanisms. As will be described hereafter, the trained machine learning model of row follower training system 1252 may be used to guide the positioning and movement of interfaces 1263 in alignment with and over plant rows 1253.

Row follower training system 1252 is similar to row follower training system 822 in that row follower training system 1252 facilitates automated generation and/or training of a machine learning model, such as machine learning model 1024 and/or machine learning model 1004 (described above), as vehicle 1250 travels along plant rows 1253. Row follower training system 1252 comprises cameras 1272-1, 1272-2, 1272-3, 1272-4, 1272-5 and 1272-6 (collectively referred to as cameras 1272), GPS 834, row map 836, steering input 838, operator interface 1268 and controller 1270.

Cameras 1272 may comprise 3D or stereo cameras or monocular cameras. Cameras 1272-1 and 1272-6 are carried by vehicle 1250 and have field of views that capture portions of wheels 1256-1 and 1256-2 and/or regions directly in front of such wheels 1256-1, and 1256-2, respectively. Cameras 1272-2 through 1272-5 are carried by vehicle 1250 and are configured to have fields of view that contain consecutive plant rows and regions therebetween. Each of such cameras 1272-2 through 1272-5 may have fields of view containing portions of respective plant interfaces 1261 and 1263. For example, camera 1272-2 has a field-of-view containing plant rows 1253-2 and 1253-3 and regions therebetween. Camera 1272-2 has a field-of-view that may also capture plant interfaces 1261-1 and portions of plant interfaces 1263-1 and 1263-2. Images from cameras 1272 are transmitted to controller 1270 for labeling and use in training machine learning model 1004 and/or machine learning model 1024.

GPS 834, row map 836 and steering input 838 are described above with respect to row follower training system 822. Operator interface 1268 comprises one or more devices by which an operator, residing on vehicle 1250 or remote from vehicle 1250, may provide further commands and/or input to vehicle 1250. For example, operator interface 1268 may be utilized by the operator to manually identify the state of vehicle 1250 for the labeling of images currently being received by one or more of cameras 1272. Operator interface 1268 may comprise a touchscreen, joystick, a pushbutton or toggle switch, slide bar, a microphone with speech recognition, touchpad, keyboard or the like.

Controller 1270 is similar to controller 840 described above in that controller 1270 receives and labels images from cameras 1272, wherein such labeled images are utilized to train or update a machine learning model. Like controller 840, controller 1270 may then utilize the trained machine learning model to evaluate the positioning of vehicle 1250 with respect to plant rows 1253 based upon unlabeled images received from at least one of cameras 1272. Based upon such an evaluation, controller 1270 may output control signals to propulsion system 1258 to adjust the speed of vehicle 1250 and may output control signals to steering system 1268 to adjust steering of wheels 1256.

In some implementations, controller 1270 may label images captured by multiple cameras at the same time or nearly same time to provide a larger number of labeled images for the training of machine learning model 1004 or 1024. For example, images captured by each of cameras 1272 may be concurrently received and labeled for the training of the machine learning model. The labeling of such images may be performed in the same manner as described above with respect to the labeling of images by row follower training system 822, being based upon signals from GPS 834 and row map 836 (as described above) and/or being based upon signals from steering input 838 (as described above).

In some implementations, machine learning model 1004 and/or machine learning model 1024 may comprise different models based upon or trained using different images. In some implementations, machine learning model 1004/1024 may include a first sub model for use in determining whether the vehicle 150 is located within a navigable space (between plant rows) or a non-navigable space (encountering a plant row), a second sub model for use in determining whether plant interfaces 1261 are properly positioned or moving between and within consecutive plant rows 1253, and a third sub model for use in determining whether plant interfaces 1263 are properly aligned with plant rows 1253. The first sub model may be trained based upon images captured by cameras 1272-1 and 1272-6 and which are labeled by controller 1270. The second and third sub models may be trained based upon images captured by cameras 1272-2 through 1272-5 and which are labeled by controller 1270.

The different sub models accommodate the different widths, tolerance characteristics and performance requirements as between wheels 1256, plant interfaces 1261 and plant interfaces 1263. For example, the first machine learning sub model may indicate that an unlabeled first image captured by camera 1272-1 may be depicting wheel 1256-1 not within a navigable space, that wheel 1256-1 is contacting or encountering or is about to encounter one of plant rows 1253-1 or 1253-2. At the same time, the second machine learning sub model may indicate that an unlabeled second image captured by camera 1272-4 at the same time as the first image is depicting plant interface 1261-3 as being sufficiently spaced from and positioned between plant rows 1253-4 and 1253-5 so as to move in within a navigable space. The third machine learning sub model may indicate that unlabeled image captured by camera 1275 is depicting plant interface 1263-5 out of adequate alignment with plant row 1253-6. Based upon a combination of the input from each of the three sub models, controller 1270 may determine and output control signals to steering system 1257 and propulsion system 1258 such that a “compromise” is achieved that results in wheels 1256 being adequately positioned between their respective plant rows to avoid encountering either of their respective consecutive plant rows while the same time adequately aligning plant interfaces 1261 between consecutive plant rows and adequately aligning plant interfaces 1263 over top of underlying plant rows 1253.

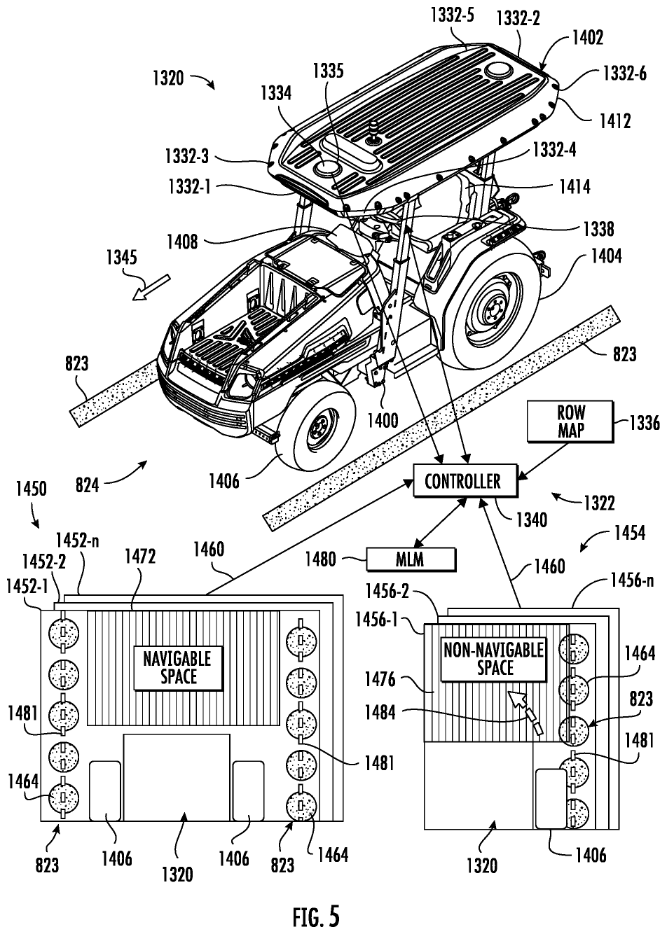

FIG. 5 is a perspective view illustrating portions of an example row follower vehicle 1320 provided as part of an example row follower training system 1322. FIG. 5 illustrates one example implementation of vehicle 820 and row follower training system 822 described above. Vehicle 1320 and system 1322 may be utilized in place of vehicle 820 as described above with respect to the larger system 1000 of FIG. 3. Vehicle 1320 is in the form of a tractor comprising frame 1400, operator cab 1402, rear wheels 1404, steered front wheels 1406, operator interfaces 1408, cameras 1332-1, 1332-2, 1332-3, 1332-4, 1332-5 and 1332-6 (collectively referred to as cameras 1332), GPS 1334, row map 1336, steering input 1338, and controller 1340.

Frame 1400 forms part of a chassis and supports the remaining components of vehicle 1320. Operator cab 1402 is supported by frame 1400 and comprises roof 1412 and operator seat 1414. Roof 1412 extends above the operator seat 1414. Operator seat 1414 provides a seat for an operator to reside during manual steering or operation of vehicle 1320.

Rear wheels 1404 engage the underlying terrain or ground to drive vehicle 1320. In some implementations, rear wheels 1404 may be replaced with tracks. In some implementations, rear wheels 1404 receive torque from an electric motor which is transmitted to rear wheels 1404 by transmission. In some implementations, rear wheels 1404 receive torque from an internal combustion engine or a hybrid between an internal combustion engine and an electric motor, wherein the torque is transmitted by a transmission to rear wheels 1404.

Steered front wheels 1406 comprise steerable wheels that may be turned to steer or control the direction of vehicle 1320 as it moves along and between consecutive crop rows 833. In some implementations, the angular positioning of steered front wheels 14 is controlled by a steer by wire system, wherein a steering actuator (hydraulic jack, electric solenoid or the like) interacts upon a rack gear or other gearing system based upon electronic signals received from controller 1340. In some implementations, steered front wheels 1406 may alternatively comprise tracks. In some implementations, steered front wheels 1406 may be powered to control their rotation relative to the rotation of rear wheels 1404. For example, in some implementations, front steered wheels 1406 may be driven by a hydraulic motor which is driven by a hydraulic pump that is driven by the electric motor.

Operator interfaces 1408 comprise those portions of vehicle 1320 which permit input from an operator. In the example illustrated, operator interfaces 1408 may be provided as part of vehicle 1320, within operator cab 1402. In some implementations, operator interface 1408 may be provided at a remote location for remote operator, wherein inputs from the operator wirelessly transmitted to vehicle 1320. In some implementations, operator interface 1408 may be provided locally on vehicle 1320, providing the option for local operator control, and may be provided remotely, providing the option for remote operator control of vehicle 1320. In implementations where operator interface 1408 are not provided as part of vehicle 1320, but are at remote locations for remote operator, vehicle cab 1402 and operator seat 1414 may be omitted. Examples of operator interface 1408, whether locally residing on vehicle 1320 or remotely located, include, but are not limited to, a touchscreen, a console pushbuttons, slide bars, toggle switches, levers, a keyboard, touchpad, a microphone with associated speech recognition software, and/or a camera for capturing operator gestures.

Cameras 1332 capture images (individually or as part of videos in some implementations) of the surroundings of vehicle 1320. Cameras 1332 may be two-dimensional or stereo (three-dimensional) cameras. In the example illustrated, cameras 1332-1 and 1332-2 face in forward and rearward directions, respectively. Cameras 1332-3 and 1332-4 face in forward right and left angled directions, respectively. Cameras 1332-5 and 1332-6 face in rearward right and left angled directions. Each of such cameras may be configured to have a field-of-view containing the adjacent consecutive crop rows 833. Images captured by such cameras are transmitted to controller 1340. In some implementations, vehicle 1320 may include additional or fewer of such cameras. In some implementations, vehicle 1320 may comprise additional or alternative cameras provided at other locations and at other angles.

GPS 1334 is supported on the roof 1412 of row follower vehicle 1320 and outputs signals that indicate the geographic location of row follower vehicle 1320 or from which the geographic location of row follower vehicle 1320 may be determined. Row map 1336 comprises a stored mapping of rows and navigable spaces between such rows. In some implementations, row map 1336 comprises geographic coordinates of various plant rows, including rows 833. Row map 1336 may be previously acquired or generated using satellite imagery data, including GPS points of various rows, or by other methods. Row map 1336 may be stored locally on row follower vehicle 1320 or may be remotely stored and accessed in a wired or wireless fashion by controller 1340.

Steering input 1338 comprises an input device by which an operator may provide steering commands to row follower vehicle 1320 as at least portions of follower vehicle 1320 are traveling along and within navigable spaces between consecutive rows 833. Steering input 1338 may be locally provided and carried by row follower vehicle 1320 where the operator resides on row follower vehicle 1320 as row follower vehicle 820 travels along navigable spaces 1324. Steering input 838 may be remote relative to row follower vehicle 1320 such as where the operator remotely controls steering of row follower vehicle 1320, wherein signals from the remote steering input 1338 may be transmitted in a wireless fashion to a steering control unit carried by row follower vehicle 1320. In some implementations, steering input 1338 may comprise a steering wheel that resides on row follower vehicle 1320 or remote from row follower vehicle 1320. In some implementations, steering input 1338 may comprise a joystick or other operator interface that facilitates input of steering commands by an operator either residing on row follower vehicle 1320 or remote from row follower vehicle 1320.

Controller 1340 carries out training of a deep learning or machine learning model, such as a neural network, wherein the model or neural network may identify navigable spaces between rows. Controller 1340 may further carry out adjustment or corrections of the model or neural network based upon operator input using steering input 1338 during the otherwise automated steering of row follower vehicle 1320 (or another vehicle that is to move along rows) based upon a previously trained model or neural network.

Controller 1340 comprises processing unit 846 and memory 848 (shown in FIG. 1). Processing unit 846 follows instructions provided in memory 848. Memory 848 comprises a non-transitory computer-readable medium which contains such instructions. Controller 1340 and camera 832 in combination with (1) steering input 1338 and/or (2) GPS 1334 and row map 1336 form or serve as the ground truth for row follower training system 1322. In some implementations, controller 1340 may carry out the example method 900 described above with respect to FIG. 2. In some implementations, controller 1340 resides locally on vehicle 1320. In some implementations, as described above with respect to system 1000, controller 1340 may be associated with a server and is located remote from vehicle 1320, wherein controller 1340 communicates wirelessly with an onboard controller of vehicle 1320.

As described above with respect to block 910 of method 900, cameras 1332 capture images at times when vehicle 1320 is completely contained within navigable space 824 and at other times when vehicle 1320 may be currently intersecting or in a path that is to intersect one of plant rows 823. FIG. 5 illustrates set 1450 of example images 1452-1, 1452-2 . . . 1452-n (collectively referred to as images 1452) and set 1454 of example images 1456-1, 1456-2 . . . 1456-n (collectively referred to as images 1456) captured by one or more of cameras 1332. As indicated by arrows 1460, the sets 1450 and 1454 of images 1452 and 1456 are transmitted to controller 1340.

In the example illustrated, the images 1452 and 1456 are taken in a forward direction (indicated by arrow 1345) and may depict front portions of vehicle 1320 as well as those plants on opposite sides of vehicle 1320. Such images 1452 and 1456 may further depict open spaces or spaces occupied by grass, or other plants having a lower height distinguishable from plants 1464. Such spaces constitute navigable spaces through and along which vehicle 1320 is intended to travel when moving between rows 832.

In the example illustrated, set 1450 comprises images 1452 taken when vehicle 1320 is traveling within a navigable space or is about to travel within a navigable space. Set 1454 comprises images 1456 taken when the vehicle 1320 is traveling along a route that coincides or intersects a plant row. When initially captured by the one or more cameras 1332, such images 1452 and 1456 are unlabeled and may be mixed in any random fashion. Each captured image is subsequently labeled by controller 1340 (or another controller) as depicting either a navigable space 1472 or a non-navigable space 1476. The labeling of such images 1452, 1456 facilitates their use in the forming of or training of a machine learning model 1480.

The labeling of images 1452, 1456 may be carried out by controller 1340 in one of two operator selectable or available training modes. Such modes may be selected via operator interface 1408. With a first mode, controller 1340 records the geographic coordinates of vehicle 1320 as vehicle 1320 travels along plant rows 833. Controller 1340 may timestamp the different geographic coordinates of vehicle 1320 as vehicle 1320 travels along plant rows 833. At the same time controller 1340 records the time at which each of the images 1452, 1456 is captured. Based upon such information or data, controller 1340 may determine the geographic coordinates of vehicle 1320 at the time of each individual image 1452, 1456. Said another way, for each of images 1452, 1456, controller 1340 may determine the particular geographic coordinates of vehicle 1320 at the time that the particular image was captured.

With the first training mode, controller 1340 further accesses a local or remote row map 1336 to identify the geographic coordinates of the current consecutive rows 833 along which in between which vehicle 1320 is traveling. Controller 1340 may use such geographic coordinates to determine, geographically the plant rows 833 are located and extend. For each captured image 1452, 1456, controller 1340 compares the geographic coordinates of the vehicle 1320 associated with the particular image to the geographic coordinates of rows 833. Based upon this comparison, controller 1340 may determine whether vehicle 1320 is in a navigable space or is not within a navigable space in the particular image. For example, if the geographic coordinates of vehicle 1320, when a particular image was captured, intersect, overlay or crossover (to the left or to the right) the geographic coordinates of the row, controller 1340 may label the particular image as depicting vehicle 1320 in a non-navigable space. Conversely, if the geographic coordinates of vehicle 1320, when a particular image was captured, do not intersect, overlay or crossover the geographic coordinates of the rows 833, controller 1340 may label the particular image as depicting vehicle 1320 in a navigable space.

In some implementations, controller 1340 may label a particular image as depicting a non-navigable space in response to the future projected path of vehicle 1320 intersecting, overlaying or crossing over the geographic coordinates of a row. The geographic coordinates of vehicle 1320 (determined from signals from GPS 1334) depicted in a particular image may not currently intersect, overlie or cross over the geographic coordinates of either of plant rows 833 (determined from row map 1336). However, in such implementations, before labeling the particular image as depicting the vehicle in a navigable space, controller 1340 may additionally determine whether vehicle 1320 is on course to intersect, overlay or overlap one of the plant rows 833 in the near future. In such implementations, controller 1340 may obtain the current yaw or direction of travel of vehicle 1320 from prior GPS readings, from an inertial measurement unit 1335 or from an angular measurement of the front steered wheels 1406 from a potentiometer or the like. Based upon the determined direction of travel, the current geographic coordinates of vehicle 1320 and its known dimensions or width, controller 1340 may determine the future trajectory or path of vehicle 1320 to determine whether vehicle 1320 is about to enter a non-navigable space. In such implementations, controller 1340 may label the particular image as depicting vehicle 1320 in a “non-navigable” space, teaching machine learning model 1480 to identify future images which are similar to the particular image, which may indicate an oncoming plant row incursion, and which may potentially trigger a course adjustment or steering adjustment for vehicle 1320.

In the example illustrated, set 1450 of images 1452 are those images in which vehicle 1320 is traveling within a navigable space 1472. The dashed or broken row lines 1481 schematically represent the geographic coordinates of plant rows 833 as acquired from row map 1336. The positioning of vehicle 1320 in each of the images has an associated set of geographic coordinates acquired from GPS 1334, as described above. For each of the images 1452 and set 1450, the geographic coordinates of vehicle 1320 (the geographic coordinates of current position and the anticipated future geographic coordinates of vehicle 1320 (assuming continuance of a linear straightforward path) the future forward path of vehicle 1320 do not overlap, intersect or crossover row lines 1481. As result, controller 1340 has labeled each of such images 1452 as depicting vehicle 1320 in a navigable space.

In the example illustrated, set 1454 of images 1456 are those images in which vehicle 1320 is traveling within a non-navigable space 1476. As before, the dashed or broken row lines 1481 schematically represent the geographic coordinates of plant rows 823 as acquired from row map 1336. The positioning of vehicle 1320 in each of the images has an associated set of geographic coordinates acquired from GPS 1334, as described above. For each of the images 1456 in set 1454, the geographic coordinates of vehicle 1320 (the geographic coordinates of current position and the anticipated future geographic coordinates of vehicle 1320) (assuming continuance of a linear straightforward path) the future forward path of vehicle 1320 overlap, intersect or crossover at least one of row lines 1481. As result, controller 1340 has labeled each of such images 1452 as depicting vehicle 1320 in a non-navigable space. Such labeled images are used to train the machine learning model 1480.

Although FIG. 5 illustrates the labeling of images 1452 and 1456 captured by forward facing cameras 1332, the same process may be applied to images captured by rearward facing cameras 1332 or side facing cameras. Such labeled images may likewise be used by controller 1340 (or server 1002) to train a machine learning model that may determine or indicate when vehicle 1320 is traveling within a navigable space or is traveling within a non-navigable space based upon future unlabeled images captured by cameras 1332. In some implementations, it is possible for the vehicle to be angled such of the front may intersect a first plant row and the rear may intersect a second plant row.

When in a second training mode, controller 1340 monitors operator inputs to steering input 1338. In such an implementation, images may be captured by cameras 1332 at a high frequency. Once a training mode is initiated and vehicle 1320 is traveling along a generally linear route (not turning into a row), and in response to vehicle 1320 continuing to be steered along a generally linear route or path, controller 1340 concludes that vehicle 1320 is traveling within a navigable space and accordingly labels those images captured by cameras 1332 at the current time and immediately preceding time as images depicting vehicle 1320 in the “navigable space”.

In contrast, in response to controller 1340 receiving signals indicating a change in yaw or turning of vehicle 1320 greater than a predetermined turning threshold, controller 1340 may determine that such turning by the operator was in response to vehicle 1320 encountering or about to encounter a plant row 823. As a result, controller 1340 may label images 1452, 1456 as depicting vehicle 1320 traveling in or about to enter a non-navigable space. Once the steering of vehicle 1320 has returned to a substantially linear straight path, controller 1340 may once again begin labeling subsequent images 1452, 1456 as depicting the vehicle traveling within a navigable space.

In such implementations, the angular extent of turning of vehicle 1320 may be determined by controller 1340 in multiple fashions. In some implementations, controller 1340 may determine the angular extent of turning by vehicle 1320 based upon the sensed turning of a steering wheel serving as steering input 1338. In some implementations, controller 1340 may determine the angular extent of turning by vehicle 1320 based upon signals from inertial measurement unit 1335. In some implementations, controller 1340 may determine the angular extent of turning by vehicle 1320 based upon signals indicating the angular position of the front steered wheels 1406 or other components that cause the angular positioning of front steered wheels 1406 two change based upon inputs received from steering input 1338.

The example image 1452-1 in FIG. 5 illustrates vehicle 1320 traveling within a navigable space 1472. During such time, vehicle 1320 is traveling along a substantially linear or straight path. At such time, controller 1340 is receiving signals indicating the turning of vehicle 1320 by the operator. Controller 1340 compares the receive turning angle and the duration of any turning to associated angle and duration thresholds. In the example illustrated, at the time that the particular image 1452-1 was captured, any turning of vehicle 1320 was at an angle less than a predetermined angle threshold and/or was for a duration of time less than a predetermined turning time threshold. As result, controller 1340 labels the particular image 1452-1 as depicting vehicle 1320 traveling in a navigable space. The labeled image 1452-1 may then be transmitted to controller 1340 for the training of machine learning model 1480.

The example image 1456-1 in FIG. 5 illustrates vehicle 1320 encountering plant row 823. At such time, controller 1340 is receiving signals indicating the turning of vehicle 1320 away from the plant row 823 by the operator (as indicated by arrow 1484). Controller 1340 compares the received turning angle to a predefined threshold. In some implementations, controller 1340 compares the receive turning angle and the duration of time of such turning to corresponding predefined thresholds. In response to the predefined thresholds being satisfied or exceeded, controller 1340 labels the particular image 1456-1 as depicting vehicle 1320 traveling in a non-navigable space. In some implementations, controller 1340 may also label a predetermined number of images preceding image 1456-1 as also depicting vehicle 1320 traveling in a non-navigable space or about to enter a non-navigable space. The labeled images may then be transmitted to controller 1340 for the training of machine learning model 1480.

In some implementations, controller 1340 additionally labels the images captured by cameras 1332 based upon the determined lateral spacing of the vehicle 1320. Such labeling may be used to develop or train an enhanced machine learning model 1480 which not only indicates whether or not the vehicle 1320 is currently traveling within a navigable space or is about to enter a non-navigable space, but also estimates the current lateral spacing between the 1320 and a plant row 823 based upon a particular unlabeled image. As result, in response to receiving unlabeled image which the machine learning model 1480 indicates as depicting vehicle 1320 about to encounter a plant row 823, controller 1340 may utilize the determined lateral distance, as also provided by the machine learning model 1480, to output control signals causing the forward speed of vehicle 1320 to be slowed and causing vehicle 1320 to be adequately turned to extent so as to avoid the otherwise forthcoming encounter with the plant row 823.

When operating in the first mode, controller 1340 may use the geographic coordinates of vehicle 1320 (as determined based on signals from GPS 1334) and the geographic coordinates of plant rows 823 (as determined from row map 1336) to determine a lateral spacing of vehicle 1320 from the plant row 823 as depicted in a particular image. Controller 1340 may then label the particular image with the determined lateral spacing. In some implementations, each of images 1452, 1456 may be labeled with their respective lateral spacings of the vehicle 1320 and either or both of plant rows 833. In some implementations, controller 1340 may label images 1452, 1456 with lateral spacing ranges, wherein a first number of images 1452, 1456 may have a first label indicating that the lateral spacing fell within a first range and a second of images 1452, 1456 may have a second label indicating that the lateral spacing depicted in the particular image fell within a second different range.

When operating in the second mode, controller 1340 may determine the lateral spacing of vehicle 1320 from plant rows 833 based upon the turning angle of vehicle 1320, the sensed speed of vehicle 1320, and the duration at which the vehicle is being turned by the operator. The lateral spacing is based upon a determination that the operator will turn vehicle 1320 at a particular turning angle, at a particular vehicle speed and for a particular duration based upon the lateral spacing of vehicle 1320 from the plant row 823 so as to reposition the vehicle 1320 between plant rows 833. A large lateral spacing may result in the operator turning the vehicle at a sharper angle, or at a lesser angle for a greater duration, whereas a small lateral spacing may result in the operator turning the vehicle at a lesser angle or at an angle for a lesser duration. The speed of vehicle may be determined controller 1340 from wheel odometry such as with a wheel encoder associated with wheels 1404 or based upon images captured by camera 1332.

Although the claims of the present disclosure are generally directed to training a machine learning model to determine whether a row follower vehicle is at the targeted row position based on images from the camera and verification that the row follower vehicle is at the targeted row position during capture of the images, the present disclosure is additionally directed to the features set forth in the following definitions.

Definition 1. A row follower training system comprising:
a camera to be coupled to a row follower vehicle;
a processing resource;
a non-transitory computer readable medium comprising instructions configured to direct the processing resource to:
capture images with a camera as the camera is moved along the consecutive rows;
for each of the images, verify that the row follower vehicle is at a targeted row position during the capture of the images;
output the images to a machine learning model to train the machine learning model to determine whether the row follower vehicle is at the targeted row position based on images from the camera and based on a verification that the row follower vehicle at the targeted row position during capture of the images; and
output steering control signals to steer the row follower vehicle or a second row follower vehicle, in an automated fashion, along other consecutive rows using the trained machine learning model and images from the camera, or a second camera coupled to the second row follower vehicle.

Definition 2. The system of Definition 1, wherein the camera is position with respect to a first one of the plant rows, the system further comprising a second camera to be coupled to a row follower vehicle with respect to a second one of the plant rows, wherein the instructions are configured to direct the processing resource to:
capture second images with the second camera as the second camera is moved along the plant rows;
for each of the second images, verify that the row follower vehicle is at the targeted row position with respect to the first one of the plant rows and the second one of the plant rows during the capture of the second images;
output the images to a machine learning model to train the machine learning model to determine whether the row follower vehicle is at the targeted row position based on images from the second camera and based on a verification that the row follower vehicle at the targeted row position during capture of the second images; and
output steering control signals to steer the row follower vehicle or a second row follower vehicle, in an automated fashion, along other plant rows using the trained machine learning model and images from the second camera, or a second camera coupled to the second row follower vehicle.

Definition 3. A row follower training system comprising:
a camera to be coupled to a row follower vehicle;
a processing resource;
a non-transitory computer readable medium comprising instructions configured to direct the processing resource to:
capture images with a camera from between consecutive rows as the camera is moved along the consecutive rows;
for each of the images, verify that the row follower vehicle is in a navigable space during the capture of the images;
output the images to a machine learning model to train the machine learning model to determine whether the row follower vehicle is within the navigable space between consecutive rows based on images from the camera and based on a verification that the row follower vehicle is in the navigable space during capture of the images; and
output steering control signals to steer the row follower vehicle or a second row follower vehicle, in an automated fashion, between other consecutive rows using the trained machine learning model and images from the camera, or a second camera coupled to the second row follower vehicle.

Definition 4. The system of Definition 3 further comprising:
a map comprising geographic locations of the consecutive rows; and
a global position satellite (GPS) system coupled to the row follower vehicle to output location signals indicating a geographic location of the row follower vehicle,
wherein the instructions are to direct the processing resource to verify that the row follower vehicle is in the navigable space between the consecutive rows based upon the map and the location signals from the GPS system.

Definition 5. The system of Definition 3, wherein the row follower vehicle is associated with an operator steering input and wherein the instructions are to direct the processing resource to verify that the row follower vehicle is in the navigable space between the consecutive rows based upon signals from the operator steering input.

Definition 6. The system of Definition 3, wherein the row follower vehicle is associated with an operator steering input and wherein the instructions are to direct the processing resource to:
interrupt automated steering of the row follower vehicle based upon signals from the operator steering input;
tag those particular images captured by the camera immediately prior to and/or during the interruption of the automated steering;
output those particular tagged images to a machine learning model to retrain the machine learning model additionally based upon those particular tagged images to determine whether the row follower vehicle is within the navigable space between consecutive rows; and
output steering control signals to steer the row follower vehicle or a second row follower vehicle, in an automated fashion, between the other consecutive rows using the retrained machine learning model and images from the camera or a second camera coupled to the second row follower vehicle.

Definition 7. The system of Definition 3 further comprising the row follower vehicle, when the row follower vehicle is selected from a group of row follower vehicles consisting of: a self-propelled agricultural vehicle; an implement or attachment pushed or pulled by a self-propelled agricultural vehicle; a tractor; and a harvester.

Definition 8. The system of Definition 3, wherein the instructions are to direct the processing resource to modify a stored row map based upon the trained machine learning model and images from the camera, or the second camera coupled to the second row follower vehicle.

Definition 9. A non-transitory computer-readable medium containing instructions to direct a processing unit, the instructions being configured to direct the processing unit to:
capture images with a camera from between consecutive rows as the camera is moved along and between the consecutive rows;
for each of the images, verify that a row follower vehicle is in a navigable space during the capture of the images;
output the images to a machine learning model to train the machine learning model to determine whether the row follower vehicle is within the navigable space between consecutive rows based on images from the camera and verification that the row follower vehicle is in the navigable space during capture of the images; and
output steering control signals to steer the row follower vehicle or a second row follower vehicle, in an automated fashion, between other consecutive rows using the trained machine learning model and images from the camera or a second camera coupled to the second row follower vehicle.
direct the processing unit to verify that the row follower vehicle is in the navigable space between the consecutive rows based upon a row map and location signals from a global positioning satellite (GPS) system.

Definition 10. The medium of Definition 9, wherein the row follower vehicle is associated with an operator steering input and wherein the instructions are to direct the processing unit to verify that the row follower vehicle is in the navigable space between the consecutive rows based upon signals from the operator steering input.

Definition 11. The medium of Definition 9, wherein the row follower vehicle is associated with an operator steering input and wherein the instructions are to direct the processing unit to:
interrupt automated steering of the row follower vehicle based upon signals from the operator steering input;
tag those particular images captured by the camera immediately prior to and/or during the interruption of the automated steering;
output those particular tagged images to a machine learning model to retrain the machine learning model additionally based upon those particular tagged images to determine whether the row follower vehicle is within the navigable space between consecutive rows; and
output steering control signals to steer the row follower vehicle or a second row follower vehicle, in an automated fashion, between the other consecutive rows using the retrained machine learning model and images from the camera or a second camera coupled to the second row follower vehicle.

Definition 12. The medium of Definition 9, wherein the instructions are configured to direct the processing unit to modify a stored row map based upon the trained machine learning model and images from the camera or the second camera coupled to the second row follower vehicle.

Definition 13. A method for steering a row follower vehicle, the method comprising:
capturing images with a camera from between consecutive rows as the camera is moved along and between the consecutive rows;
for each of the images, verifying that the row follower vehicle is in a navigable space during the capture of the images;
outputting the images to a machine learning model to train the machine learning model to determine whether the row follower vehicle is within the navigable space between consecutive rows based on images from the camera and verification the row follower vehicle is in the navigable space during capture of the images; and
outputting steering control signals to steer the row follower vehicle or a second row follower vehicle, in an automated fashion, between other consecutive rows using the trained machine learning model and images from the camera or a second camera coupled to the second row follower vehicle.

Definition 14. The method of Definition 13 wherein the verification of whether the row follower vehicle is in the navigable space between the consecutive rows is based upon a row map and location signals from a global positioning satellite (GPS) system.

Definition 15. The method of Definition 14, wherein the verification of whether the row follower vehicle is in the navigable space between the consecutive rows is based upon signals from an operator steering input.

Definition 16. The method of Definition 13 further comprising:
interrupting automated steering of the row follower vehicle based upon signals from an operator steering input;
tagging those particular images captured by the camera immediately prior to and/or during the interruption of the automated steering;
outputting those particular tagged images to a machine learning model to retrain the machine learning model additionally based upon those particular tagged images to determine whether the row follower vehicle is within the navigable space between consecutive rows; and
outputting steering control signals to steer the row follower vehicle or a second row follower vehicle, in an automated fashion, between the other consecutive rows using the retrained machine learning model and images from the camera or a second camera coupled to the second row follower vehicle.

Definition 17. The method of Definition 13 further comprising modifying a stored row map based upon the trained machine learning model and images from the camera or the second camera coupled to the second row follower vehicle.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A row follower training system comprising:
a camera to be coupled to a row follower vehicle;
a processing resource;
a non-transitory computer readable medium comprising instructions configured to direct the processing resource to:
capture images with a camera as the camera is moved along plant rows;
for each of the images, verify that the row follower vehicle is at a targeted row position during the capture of the images;
output the images to a machine learning model to train the machine learning model to determine whether the row follower vehicle is at the targeted row position based on images from the camera and based on a verification that the row follower vehicle at the targeted row position during capture of the images; and
output steering control signals to steer the row follower vehicle or a second row follower vehicle, in an automated fashion, along other consecutive rows using the trained machine learning model and images from the camera, or a second camera coupled to the second row follower vehicle.

2. The system of claim 1 further comprising:
a map comprising geographic locations of the consecutive rows; and
a global position satellite (GPS) system coupled to the row follower vehicle to output location signals indicating a geographic location of the row follower vehicle,
wherein the instructions are to direct the processing resource to verify that the row follower vehicle is at the targeted row position based upon the map and the location signals from the GPS system.

3. The system of claim 1, wherein the row follower vehicle is associated with an operator steering input and wherein the instructions are to direct the processing resource to verify that the row follower vehicle is at the targeted row position based upon signals from the operator steering input.

4. The system of claim 1, wherein the row follower vehicle is associated with an operator steering input and wherein the instructions are to direct the processing resource to:
interrupt automated steering of the row follower vehicle based upon signals from the operator steering input;
tag those particular images captured by the camera immediately prior to and/or during the interruption of the automated steering;
output those particular tagged images to a machine learning model to retrain the machine learning model additionally based upon those particular tagged images to determine whether the row follower vehicle is at the targeted row position; and
output steering control signals to steer the row follower vehicle or a second row follower vehicle, in an automated fashion, along rows using the retrained machine learning model and images from the camera or a second camera coupled to the second row follower vehicle.

5. The system of claim 1 further comprising the row follower vehicle, when the row follower vehicle is selected from a group of row follower vehicles consisting of: a self-propelled agricultural vehicle; an implement or attachment pushed or pulled by a self-propelled agricultural vehicle; a tractor; and a harvester.

6. The system of claim 1, wherein the instructions are to direct the processing resource to modify a stored row map based upon the trained machine learning model and images from the camera, or the second camera coupled to the second row follower vehicle.

7. The system of claim 1, wherein the targeted row position is a position at which a frame of the vehicle is within a navigable space between consecutive rows.

8. The system of claim 1, wherein the targeted row position is a position at which multiple plant interfaces of the vehicle are between multiple respective pairs of consecutive rows.

9. The system of claim 1, wherein the targeted row position is a position at which multiple plant interfaces of the vehicle are aligned with multiple respective rows.

10. The system of claim 1, wherein the camera is to be positioned at a first position with respect to a first one of the plant rows, the system further comprising a second camera to be coupled to a row follower vehicle at a second position, with respect to a second one of the plant rows, wherein the instructions are configured to direct the processing resource to:
capture second images with the second camera as the second camera is moved along the plant rows;
for each of the second images, verify that the row follower vehicle is at the targeted row position with respect to the first one of the plant rows and the second one of the plant rows during the capture of the second images;
output the images to a machine learning model to train the machine learning model to determine whether the row follower vehicle is at the targeted row position based on images from the second camera and based on a verification that the row follower vehicle at the targeted row position during capture of the second images; and
output steering control signals to steer the row follower vehicle or a second row follower vehicle, in an automated fashion, along other plant rows using the trained machine learning model and images from the second camera, or a second camera coupled to the second row follower vehicle.

11. A non-transitory computer-readable medium containing instructions to direct a processing unit, the instructions being configured to direct the processing unit to:
capture images with a camera from between consecutive rows as the camera is moved along the consecutive rows;
for each of the images, verify that a row follower vehicle is at a targeted row position during the capture of the images;
output the images to a machine learning model to train the machine learning model to determine whether the row follower vehicle is at the targeted row position based on images from the camera and verification that the row follower vehicle is at the targeted row position during capture of the images; and
output steering control signals to steer the row follower vehicle or a second row follower vehicle, in an automated fashion, along the rows using the trained machine learning model and images from the camera or a second camera coupled to the second row follower vehicle.

12. The medium of claim 11, wherein the instructions are to direct the processing unit to verify that the row follower vehicle is at the targeted row position based upon a row map and location signals from a global positioning satellite (GPS) system.

13. The medium of claim 11, wherein the row follower vehicle is associated with an operator steering input and wherein the instructions are to direct the processing unit to verify that the row follower vehicle is at the targeted row position based upon signals from the operator steering input.

14. The medium of claim 11, wherein the row follower vehicle is associated with an operator steering input and wherein the instructions are to direct the processing unit to:
interrupt automated steering of the row follower vehicle based upon signals from the operator steering input;
tag those particular images captured by the camera immediately prior to and/or during the interruption of the automated steering;
output those particular tagged images to a machine learning model to retrain the machine learning model additionally based upon those particular tagged images to determine whether the row follower vehicle is at the targeted row position; and
output steering control signals to steer the row follower vehicle or a second row follower vehicle, in an automated fashion, using the retrained machine learning model and images from the camera or a second camera coupled to the second row follower vehicle.

15. The medium of claim 11, wherein the instructions are configured to direct the processing unit to modify a stored row map based upon the trained machine learning model and images from the camera or the second camera coupled to the second row follower vehicle.

16. The medium of claim 11, wherein the targeted row position is a position at which a frame of the vehicle is within a navigable space between the consecutive rows.

17. The medium of claim 11, wherein the targeted row position is a position at which multiple plant interfaces of the vehicle are between multiple respective pairs of consecutive rows.

18. The medium of claim 11, wherein the targeted row position is a position at which multiple plant interfaces of the vehicle are aligned with multiple respective rows.

19. A method for steering a row follower vehicle, the method comprising:
capturing images with a camera from between consecutive rows as the camera is moved along and between the consecutive rows;
for each of the images, verifying that the row follower vehicle is in a navigable space during the capture of the images;
outputting the images to a machine learning model to train the machine learning model to determine whether the row follower vehicle is within the navigable space between consecutive rows based on images from the camera and verification the row follower vehicle is in the navigable space during capture of the images; and
outputting steering control signals to steer the row follower vehicle or a second row follower vehicle, in an automated fashion, between other consecutive rows using the trained machine learning model and images from the camera or a second camera coupled to the second row follower vehicle.

20. The method of claim 19 further comprising:
interrupting automated steering of the row follower vehicle based upon signals from an operator steering input;
tagging those particular images captured by the camera immediately prior to and/or during the interruption of the automated steering;
outputting those particular tagged images to a machine learning model to retrain the machine learning model additionally based upon those particular tagged images to determine whether the row follower vehicle is within the navigable space between consecutive rows; and
outputting steering control signals to steer the row follower vehicle or a second row follower vehicle, in an automated fashion, between the other consecutive rows using the retrained machine learning model and images from the camera or a second camera coupled to the second row follower vehicle.
